(19) United States
(12) Patent Application Publication
(10) Pub. No.: US 2016/0342953 A1
(43) Pub. Date: Nov. 24, 2016

(54) CALENDAR SCHEDULING

(71) Applicant: HEWLETT PACKARD ENTERPRISE DEVELOPMENT LP, Houston, TX (US)

(72) Inventors: Joshua Hailpern, Sunnyvale, CA (US); William J. Allen, Corvallis, OR (US)

(21) Appl. No.: 15/114,747

(22) PCT Filed: Mar. 3, 2014
(86) PCT No.: PCT/US14/19938

§ 371 Date: Jul. 27, 2016

(51) Int. Cl. G06Q 10/10

(52) U.S. Cl. CPC G06Q 10/1095

(57) ABSTRACT

Systems and methods associated with calendar scheduling are disclosed. One example method includes generating a first calendar event based on an input received from a user. The method also includes assigning a priority to the first calendar event. The method also includes selecting a second calendar event to reschedule based on a priority of the second calendar event and the priority of the first calendar event. The method also includes scheduling the first calendar event in a time slot at least partially overlapping a time slot previously associated with the second calendar event. The method also includes modifying the priority of the first calendar event over time to deter rescheduling of the first calendar event.

### BACKGROUND

Calendar management and scheduling in a business can take up a large amount of time. Some businesses even hire individuals to handle the schedules of important executives within the business. However, scheduling is not solely a difficult issue for executives, as lower level employees may also spend significant time scheduling an important event if schedules of individuals are already near full.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates example scheduling operations that may be performed on a calendar.

FIG. 2 illustrates a flowchart of example operations associated with calendar scheduling.

FIG. 3 illustrates another of example operations associated with node cluster synchronization.

FIG. 4 illustrates an example calendar scheduling system.

FIG. 5 illustrates another example calendar scheduling system.

FIG. 6 illustrates an example computing environment in which example systems and methods and equivalents, may operate.

### DETAILED DESCRIPTION

Systems and methods associated with calendar scheduling are described. In various examples, automatic calendar event scheduling may be achieved by assigning events priorities based on, for example, a person's role within an organization (e.g., a CEO's time may be more important than other employees). Calendar events may be automatically scheduled based on event priorities and on constraints associated with events (e.g., a time period during which the event should occur). As new events are added to a calendar, other events with lower priorities and/or non-conflicting constraints may be moved aside so that many events may fit into a calendar. Further, as an event draws nearer to the date and/or time at which the event is scheduled to occur, the event's priority may be raised to deter rescheduling of the event shortly before the event.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples Also, the examples may be used in combination with each other.

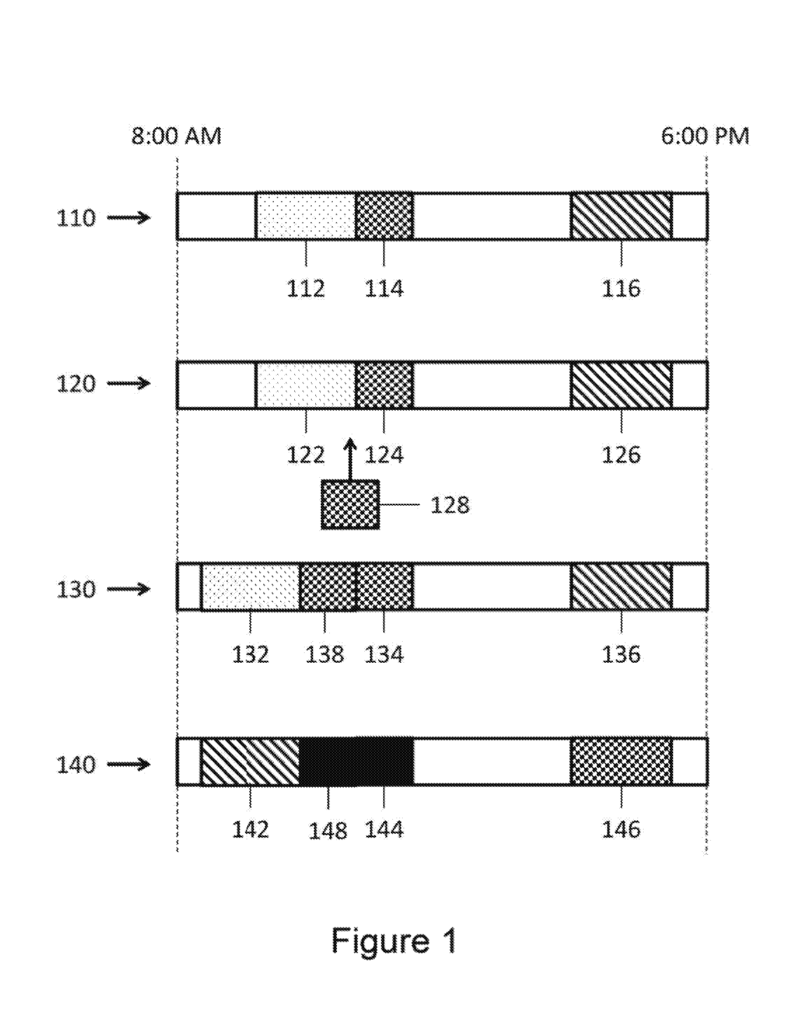

FIG. 1 illustrates example scheduling operations that may be performed on a calendar. Four example schedules 110, 120, 130, and 140 are illustrated. Schedule 110 illustrates an original state of a schedule including three events 112, 114, and 116 having differing priorities. In this example, darker shadings indicate a higher priority has been assigned to an event. Thus, in schedule 110, event 112 has a relatively low priority, event 116 has a medium priority, and event 114 has a relatively high priority. The priorities designate an importance level of an event. There are many different ways to designate a priority of an event. For example, event priority may be based on who is scheduling the event. By way of illustration, an event involving a CEO whose time is very valuable may have a higher priority than an event involving lower level employees. Certain event types may also be assigned lower priorities. For example, business critical meetings may have high priorities while social gatherings may have lower priorities.

Priorities may be used for determining whether to reschedule or cancel an event, as well as for selecting an event to reschedule or cancel when an event with a higher priority is added to a calendar. Schedules 120 and 130 illustrate a decision being made when a high priority event 128 is added to a schedule. In this example, a preferred time for event 128 overlaps with both event 122 and 124 in schedule 120. Event 126 may be unaffected by the addition of event 128 to schedule 120. Because event 122 has a lower priority than event 124, event 122 may be selected for rescheduling resulting in schedule 130. Schedule 130 illustrates a potential modified schedule as a result of adding event 128 to schedule 120. Specifically, event 138 appears between events 134 and event 132, which was moved to accommodate the new, higher priority event 138. As mentioned above, in, this example, event 136 was unaffected.

Other factors may also be taken into account when determining whether to reschedule an event. For example, even though event 122 has the lowest priority, if event 122 is constrained to only be able to occur at the specific time slot in which it has been allocated (or otherwise be cancelled), and event 124 is more flexible, it may be appropriate to reschedule event 124 rather than cancel event 122 when adding event 128 to the calendar. There are many possible ways in which event 122 (and other events generally) may be constrained which are described below. Alternatively, if the user on whose calendar event 128 is being scheduled is a non-critical attendee of events 122, 124, and/or 128, the events may be scheduled in overlapping time slots.

Schedule 140 illustrates an example operation that may be performed on schedule 130 as time passes. Because users may desire some degree of finality in their schedules as events come closer to their respective start times, events may have their priorities adjusted so they are less likely to be rescheduled. Thus, event 142 is increased to a medium priority, events 144 and 148 are increased to a very high priority, and event 148 is increased to a high priority.

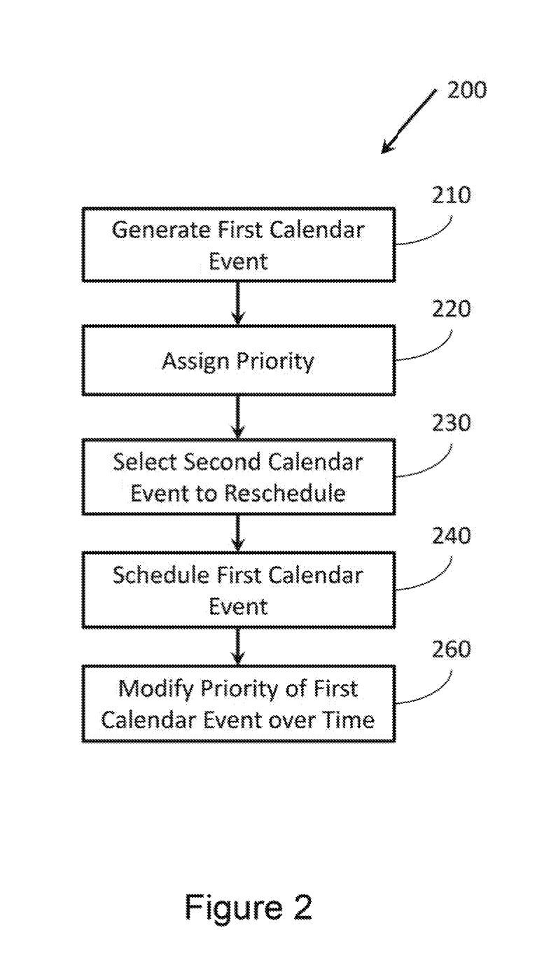

FIG. 2 illustrates a method 200 associated with calendar scheduling. Method 200 includes generating a first calendar event at 210. The first calendar event may be generated based on an input received from a user. The input may be received, for example, via a graphical user interface. The interface may allow the user to input when the user would like to schedule the event, whether there are constraints as to when the event may be scheduled, who the user would like to attend the event, and so forth. In another example, a context aware email client may attempt to schedule an event (e.g., a meeting, a date, a party, etc.) when a user begins discussing it in an email. In this example, a user may refer to a person or a logic generating an input on behalf of a user. Thus, an automatically generated calendar event (e.g., due to a recurring event) is contemplated as an input received from a user.

Method 200 also includes assigning a priority to the first calendar event at 220. In one example, the priority may be assigned based on a user input, effectively fixing the priority of the event at least initially. A user may decide, for example, to assign an event a low priority when the event is one the user does not mind being cancelled or rescheduled (e.g., a weekly recurring lunch with a friend) if a more important event needs to be scheduled in an overlapping time slot. Alternatively, a user may assign an event a high priority if the user does not want the event to be rescheduled. Example high priority events may include, for example, business critical meetings, or personal obligations outside of work that the user budgets time for (e.g., a day a person needs to leave early to pick up a child from school).

In another example, the priority may be assigned based on a position the used within an organization or of a desired attendee of the calendar event within the organization. For example, a priority of an event involving an executive may be higher than an event involving a lower level employee. The priority may also be assigned based on whether an attendee is a member of the organization. Assigning a different priority to events having attendees who are not members of the organization may be important because an attendee who is not a member of the organization may not have a flexible schedule, or a way to automatically reschedule events if the time of an event changes. Thus, an event having an attendee who is not a member of the organization may be assigned a higher priority than a similar event where all attendees are members of the organization. In some examples the user providing the input generating the request may not be an attendee of the event This may occur because, for example, the user is a logic automatically generating the event, or the user is scheduling the event on behalf of another person.

In one example, the first calendar event may be characterized by a constraint. Many different constraints are possible. The constraint may be related to a relative timing of the first calendar event and a third calendar event. This type of constraint may ensure that, for example, the first event occurs before the third calendar event or that the first event and the third calendar event occur within a designated portion of time. The constraint may be related to a time period during which the first calendar event should occur. The time period may be a time period during a day, a week, a month, and so forth. The constraint may be related to an attendee of the first calendar event. By way of illustration a constraint related to an attendee may be that if the attendee cannot attend the event, the event may have to be cancelled. Thus a constraint may cause availability of the attendee to be checked when rescheduling such an event. The constraint may be related to a number of attendees of the first ender event. For example, if a quorum is required for a meeting, a constraint may be put in place to ensure that enough desired attendees are available at the event time.

The constraint may be related to a frequency of the first calendar event. For example, some events may occur approximately once a week or once a month, but with flexibility as to when the event is scheduled during that time period. The constraint may be related to other calendar events associated with the user. For example, if a user is available on certain days due to, for example, travel plans, a constraint may be placed to ensure the user can attend the event on days the use available. The constraint may be related to other calendar events associated with the user and/or other calendar events associated with attendees of the first calendar event. Thus, constraints may serve as constraints on other calendar events by indicating when an event can and can't be scheduled. The constraint may be related to constraints associated with other calendar events of the user and/or attendees of the first calendar event.

The constraint may be related to a proximity of the first calendar event to a start of a work day, an end of a work day, a day off (e.g., holiday, weekend, vacation day), or a designated break time during a given day. A user may apply such a constraint to ensure that the user has enough time to perform daily tasks at the beginning or end of a day or week. The constraint may be related to a required amount of break time during a given day for a user or an attendee of the first calendar event. This type of constraint may facilitate, compliance with a law and or a contract mandating certain time off during a day for an attendee of an event. The constraint may be related to a relationship between the user and an attendee of the first calendar event. By way of illustration, a meeting placed on an employee's calendar by that employee's manager may have a higher priority than a meeting placed by a coworker of the employee.

The constraint may be related to a location at which the first calendar event is designated to occur. This type of constraint may facilitate location scheduling. The constraint may be related to an availability of a resource to be used at the first calendar event. In one example, locations and resources may be effectively treated as attendees having a fixed amount of availability during a day. Thus, in one example an attendee may be a resource that is desired to have in attendance at an event. The constraint may be related to proximity of the first calendar event to another calendar event.

The priority of the calendar event may be assigned based on the constraint. By way of illustration, depending on how restrictive a constraint is (e.g., because it limits the flexibility of rescheduling of an event) a priority of an event may be increased to prevent it from being rescheduled away from a constraint.

Method 200 also includes selecting a second calendar event to reschedule at 230. The second calendar event may be selected based on a priority of the second calendar event and on the priority assigned to the first calendar event at 220. By way of illustration, if the first event has a high priority and the second event has low priority, and the first event and the second event have a time conflict, the first event may be given priority and the second event may be selected for rescheduling. Alternatively, if the first event has a high priority and some flexibility in when the first event can be scheduled a second event may be selected for rescheduling based on which of several events has the lowest priority.

The second calendar event may also be selected based on a constraint associated with the second calendar event and the constraint associated with the first calendar event. Thus, where multiple events are scheduled, a second event may be selected for rescheduling despite having a higher priority than a third event if constraints associated with the second event allow the second event to be rescheduled more easily than the third event without violating a constraint. Method 200 also includes scheduling the first calendar event in a time slot at 240. The time slot may be at least partially overlapping a time slot previously associated with the second calendar event. The partial overlap may be due to, for example, differing event lengths and/or differing start and/or end times.

Method 200 also includes modifying the priority of the first calendar event over time at 260. Modifying the priority of the first calendar event may deter rescheduling of the first calendar event. Increasing the priority of calendar events over time may be valuable because it may be undesirable to change when an event occurs the day of or week of the event. By way of illustration if a user has two meetings scheduled for a day and needs to prepare for both meetings, switching the order of meetings shortly before the day on which the meetings are scheduled may leave the user unprepared for one of the meetings. The priority of the first calendar event may be modified based on how soon the first calendar event is scheduled to occur. Thus, if an event is scheduled to occur in the near future the event may be assigned a higher priority to deter rescheduling of that event. The priority of the first calendar event may also be modified based on how long the calendar event has been scheduled in the time slot. Thus, an event that has been scheduled well in advance may be given higher priority than an event scheduled at the last minute, other factors being similar.

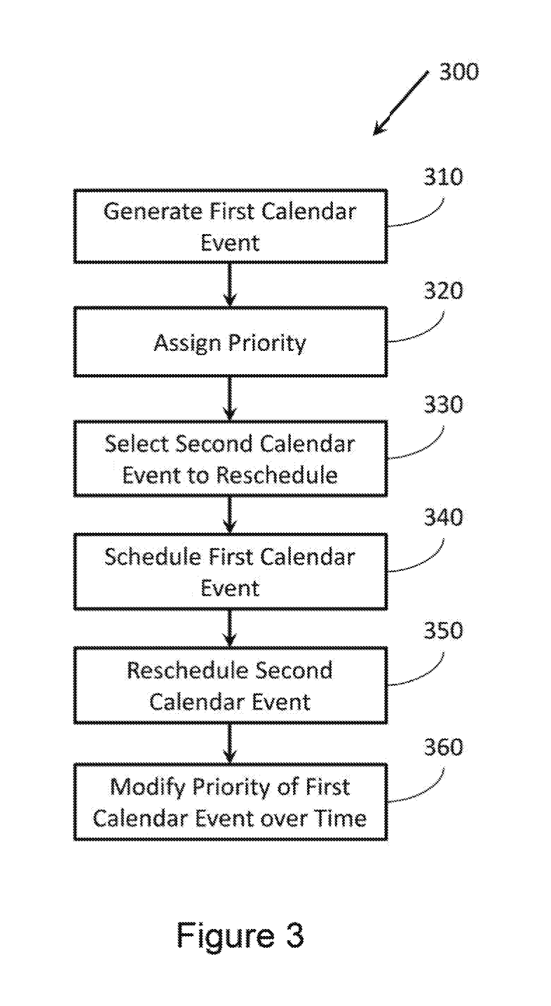

FIG. 3 illustrates a method 300 associated with calendar scheduling. Method 300 includes any actions similar to those described with reference to method 200 (FIG. 2 above). For example, method 300 includes generating a first calendar event at 310, assigning a priority to the first calendar event at 320, selecting a second calendar event to reschedule at 330, scheduling the first calendar event at 340, and modifying the priority of the first calendar event over time at 360.

Method 30 also includes rescheduling the second calendar event at 350. The rescheduling may be performed based on a constraint associated with the second event. In one example, a third event may be rescheduled to ensure that the second event remains scheduled. Whether this process continues may depend on constraints and on priorities associated with various events. An alternative version of method 300 may include cancelling the second event instead of rescheduling the second event. This may occur if constraints and/or priorities make it so that it is no longer appropriate to keep the second calendar event scheduled. In this case notifications of the cancellation of the second event may be provided to the user, attendees of the event, and/or other interested parties. Notifications may also be provided when an event is rescheduled.

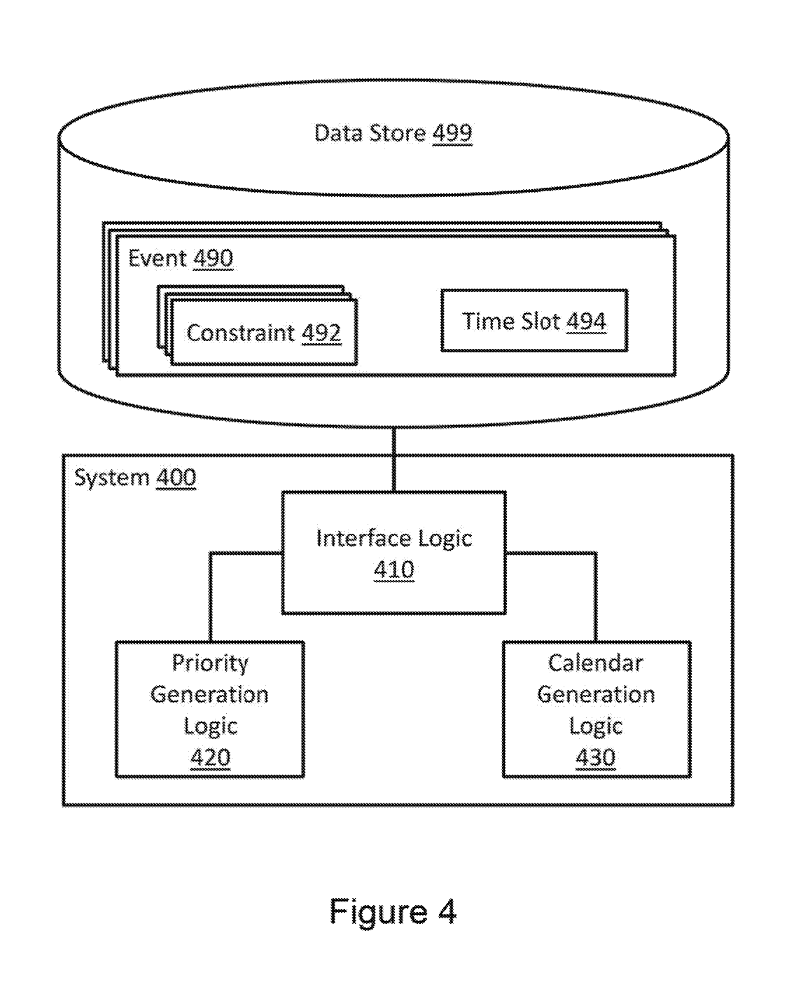

FIG. 4 illustrates an example calendar scheduling system 400. System 400 includes an interface logic 410. Interface logic 410 may interface with a data store 499. Data store 499 may store a set of events. A first event 490 may be characterized by a set of constraints 492. The first event may also be associated with a time slot 494. System 400 also includes a priority generation logic 420 to assign a priority to the first event. Priority generation logic 420 may assign the priority based on a member of the set of constraints 492. As detailed above, the constraints may be associated with users and may include roles of users when assigning priorities to events. Priority generation logic 420 may also assign the priority based on how near in tin e the first event is scheduled to occur.

System 400 also includes a calendar generation logic 430. Calendar generation logic 430 may provide a calendar of events to a user. The calendar of events may be generated from members of the set of events (e.g., event 490). The calendar may be generated using, for example, a knapsack algorithm, or a greedy algorithm. A greedy algorithm may, for example, select the highest priority event and schedule that event, meeting the constraints of that event. The greedy algorithm may then proceed down event priorities until all events are scheduled, or no more events can be scheduled due to a full calendar. A knapsack algorithm may attempt to assign events in an attempt to build an optimal calendar based on constraints including areas in a calendar in which the events could fit, while maximizing a total priority of events to ensure the maximum value of the calendar to the user.

Calendar generation logic 430 may also modify the time slot of the first event to accommodate a second event when the second event has a higher priority than the first event. Thus, if a new event is added to the calendar, the first event may be rescheduled if the second event has a higher priority than the first event.

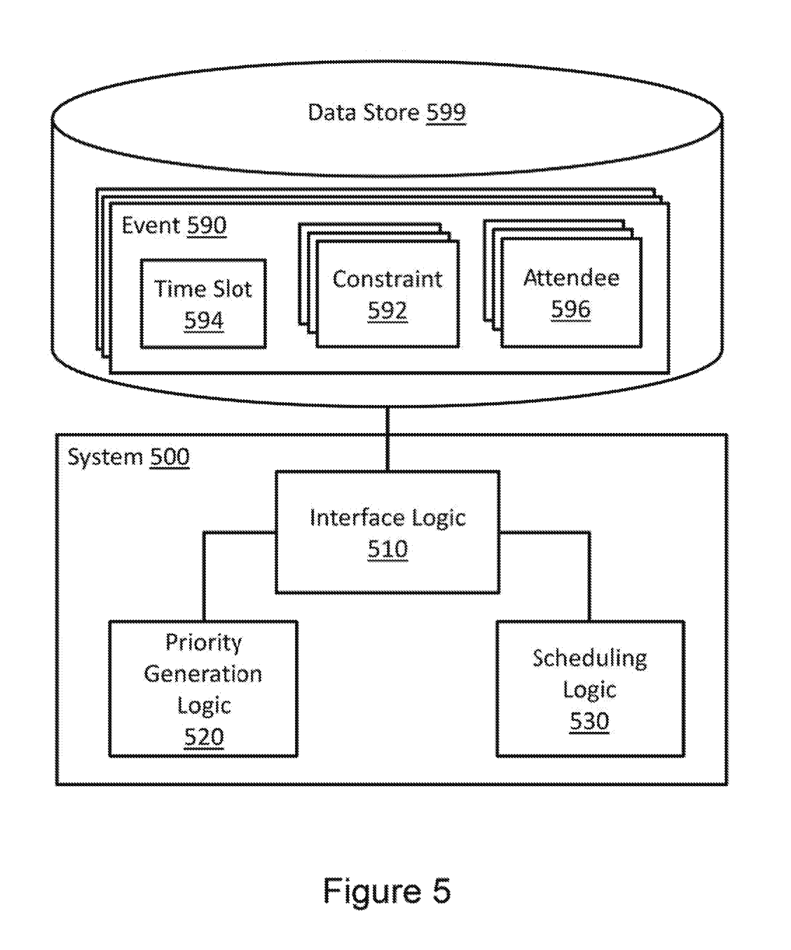

FIG. 5 illustrates an example calendar scheduling system 500. Calendar scheduling system 500 may be, for example, an enterprise calendar management system. System 500 includes an interface logic 510 to interface with a data store 599. Data store 599 stores a set of events. An event (e.g., event 590) includes a set of attendees 596. At least one attendee may be a member of an organization operating the enterprise calendar management system. Event 590 also includes a set of constraints 592. Event 590 also includes a time slot 594 at which the event is scheduled to occur. System 500 also includes a priority generation logic 520. Priority generation logic 520 may assign a priority to the event based on, for example, an attribute of an attendee, a constraint, how near in time the event is scheduled to occur, and so forth.

System 500 also includes a scheduling logic 530. Scheduling logic 530 may automatically generate calendars for members of the organization. Scheduling logic 530 may also automatically administer rescheduling of events. In one example, events with a higher priority may be less likely to be rescheduled. The calendar generation and the rescheduling administration performed by scheduling logic 530 may be performed according to constraints and on priorities associated with members of the set of events. In one example, an event having, an attendee from outside the organization may be assigned a priority higher than a similar event having all attendees as members of the organization. Reducing the likelihood that an event with an attendee from outside the organization is rescheduled may be valuable because persons outside the organization may not have flexible schedules or a way to have events automatically rescheduled if another event is modified.

In one example, scheduling logic 530 may automatically attempt to reschedule an event in response to a user rejecting a time slot of an event. Thus, upon receiving a proposed calendar from scheduling logic 530, a use may decide that the timing of a meeting is inconvenient. In this example, the user may reject a time slot of an event which may cause scheduling logic 530 to attempt to find a different time slot for the meeting, assuming constraints can be met. This may cause scheduling logic 530 to provide a different calendar to the user, depending on various factors including priorities and constraints of various events.

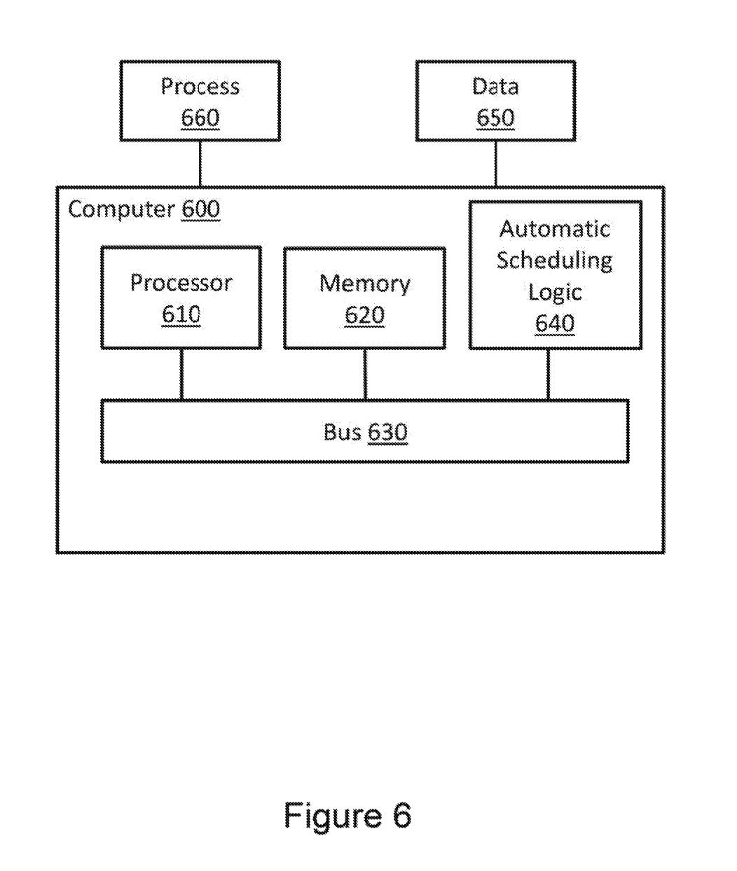

FIG. 6 illustrates an example computing environment in which example systems and methods, and equivalents, may operate. The example computing environment may be a computer 600 that includes a processor 610 and a memory 620 connected by a bus 630. The computer 600 includes an automatic scheduling logic 640. In different examples, automatic scheduling logic 640 may be implemented as a non-transitory computer-readable medium storing computer-executable instructions in hardware, software, firmware, an application specific integrated circuit, and/or combinations thereof.

The instructions may also be presented to computer 600 as data 650 or process 660 that are temporarily stored in memory 620 and then executed by processor 610. The processor 610 may be a variety of various processors including dual microprocessor and other multi-processor architectures. Memory 620 may include volatile memory (e.g., read only memory) and/or non-volatile memory (e.g., random access memory). Memory 620 may also be, for example, a magnetic disk drive, a solid state disk drive, a floppy disk drive, a tape drive, a flash memory card, an optical disk, and so on. Thus, Memory 620 may store process 660 and/or data 650. Computer 600 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. An automatic meeting scheduling method, comprising:
generating a first calendar event based on an input received from a user;
assigning a priority to the first calendar event;
selecting a second calendar event to reschedule based on a priority of the second calendar event and the priority of the first calendar event;
scheduling the first calendar event in a time slot at least partially overlapping a time slot previously associated with the second calendar event; and
modifying the priority of the first calendar event over time to deter rescheduling of the first calendar event.

2. The automatic meeting scheduling method of claim 1, where the priority is assigned to the first calendar event based on one or more of:
a position of the user within an organization,
a position of an attendee of the calendar event within the organization.
whether an attendee is a member of the organization, and
a user input,

3. The automatic meeting scheduling method of claim 1, where the first calendar event is characterized by a constraint.

4. The automatic meeting scheduling method of claim 3, where the constraint is related to one of,
relative timing of the first calendar event to a third calendar event,
a time period during which the first calendar event should occur,
an attendee of the first calendar event,
a number of attendees of the first calendar event,
a frequency of the first calendar event,
other calendar events associated with the user,
constraints of other calendar events associated with the user,
other calendar events associated with attendees of the first calendar event,
constraints of other calendar events associated with an attendee of the first calendar event,
a proximity of the first calendar event to one or more of: a work start time, a work end time, a day off, and a designated break period during the day,
a required amount of break time during a given day for the user,
a required amount of break time during a given day for an attendee of the first calendar event,
a relationship between the user and an attendee of the first calendar event,
a location at which the first calendar event is designated to occur,
an availability of a resource to be used at the first calendar event, and
a proximity of the first calendar event to another calendar event.

5. The automatic meeting scheduling method of claim 3, where the priority of the first calendar event is assigned based on the constraint.

6. The automatic meeting scheduling method of claim 3, where the second calendar event is selected based on a constraint associated with the second calendar event and the constraint associated with the calendar event.

7. The automatic meeting scheduling method of claim 1, comprising rescheduling the second calendar event.

8. The automatic meeting scheduling method of claim 1, where the priority of the first calendar event is modified based on one or more of
how soon the first calendar event is scheduled to occur, and
how long the first calendar event has been scheduled in the time slot.

9. An automatic scheduling system, comprising:
an interface logic to interface with a data store storing a set of events, where a first event is characterized by a set of constraints, and where the first event is associated with a time slot;
a priority generation logic to assign a priority to the first event based on a member of the set of constraints and on how near in time the first event is scheduled to occur; and
a calendar generation logic to provide a calendar of events to a user, where the calendar of events is generated from members of the set of events, and where the calendar generation logic modifies the time slot of the first event to accommodate a second event when the second event has a higher priority than the first event.

10. The automatic scheduling system of claim 9, where the calendar is Generated using one of, a knapsack algorithm and a greedy algorithm.

11. An enterprise calendar management system, comprising:
an interface logic to interface with a data store storing a set of events, where an event comprises:
a set of attendees, where at least one attendee is a member of an organization operating the enterprise calendar management system;
a set of constraints; and
a time slot at which the event is scheduled to occur:
a priority generation logic to assign a priority to the event based on one or more of an attribute of an attendee, a constraint, and how near in time the event is scheduled to occur; and
a scheduling logic to automatically generate calendars for members of the organization and to automatically administer rescheduling of events, where the calendar generation and the rescheduling administration is performed based on constraints and on priorities associated with members of the set of events.

12. The enterprise calendar management system of claim 11, where an event with an attendee from outside the organization is assigned a priority higher than a priority assigned to a similar event with all attendees being members of the organization.

13. The enterprise calendar management system of claim 11, where events are less likely to be rescheduled when they have a higher priority.

14. The enterprise calendar management system of claim 11, where the priority generation logic assigns a first priority for the event a first attendee and a second priority for the event to a second attendee.

15. The enterprise calendar management system of claim 11, where the scheduling logic automatically attempts to reschedule an event in response to user rejecting a time slot of an event.
